(19) United States
(12) Patent Application Publication
(10) Pub. No.: US 2014/0374589 A1
(43) Pub. Date: Dec. 25, 2014

(54) METHOD AND APPARATUS FOR IMPROVED SENSITIVITY IN A MASS SPECTROMETER

(71) Applicant: DH Technologies Development Pte. Ltd., Singapore (SG)

(72) Inventors: Hassan Javaheri, Richmond Hill (CA); Bruce A. Thomson, Toronto (CA)

(73) Assignee: DH Technologies Development Pte. Ltd, Singapore (SG)

(21) Appl. No.: 14/375,497

(22) PCT Filed: Feb. 1, 2013
(86) PCT No.: PCT/IB2013/000137

§ 371 Date: Jul. 30, 2014

Related U.S. Application Data
(60) Provisional application No. 61/593,580, filed on Feb. 1, 2012.

(51) Int. Cl. H01J 49/06; H01J 49/24; H01J 49/00; H01J 49/26

(52) U.S. Cl. CPC H01J 49/063; H01J 49/26; H01J 49/24; H01J 49/0031
USPC 250/282; 250/288

(57) ABSTRACT

Ions are generated in a high pressure region and are passed into a vacuum chamber having an inlet and an exit aperture. The configuration of the inlet aperture and the pressure difference between the high pressure region and the vacuum chamber provides a supersonic free jet expansion that has a barrel shock of predetermined diameter. At least one ion guide is provided between the inlet and exit apertures having a predetermined cross-section defining an internal volume wherein the cross-section of the at least one ion guide is sized to be at least 50% of the predetermined diameter of the barrel shock of the supersonic free jet expansion. An RF voltage is provided to the at least one ion guide. Radial gas conductance is reduced in a first section of the at least one ion guide for damping shock waves resulting from the supersonic free jet expansion.

### RELATED APPLICATION

This application claims priority to U.S. provisional application No. 61/593,580, filed Feb. 1, 2012, which is incorporated herein by reference in its entirety.

### FIELD

The applicant's teachings relate to a method and apparatus for improved sensitivity in a mass spectrometer, and more specifically to ion guides for transporting ions.

### INTRODUCTION

In mass spectrometry, sample molecules are converted into ions using an ion source, in an ionization step, and then detected by a mass analyzer, in mass separation and detection steps. For most atmospheric pressure ion sources, ions pass through an inlet aperture prior to entering an ion guide in a vacuum chamber. The ion guide transports and focuses ions from the ion source into a subsequent vacuum chamber, and a radio frequency signal can be applied to the ion guide to provide radial focusing of ions within the ion guide. However, during transportation of the ions through the ion guide, ion losses can occur. Therefore, it is desirable to increase transport efficiency of the ions along the ion guide and prevent the loss of ions during transportation to attain high sensitivity.

### SUMMARY

In view of the foregoing, the applicant's teachings provide a mass spectrometer apparatus for performing mass analysis. The apparatus comprises an ion source for generating ions from a sample in a high-pressure region, for example, at atmospheric pressure, and a vacuum chamber for receiving the ions. The vacuum chamber has an inlet aperture for passing the ions from the high-pressure region into the vacuum chamber. The vacuum chamber also has an exit aperture for passing ions from the vacuum chamber wherein the configuration of the inlet aperture and the pressure difference between the high pressure region and the vacuum chamber provides a supersonic free jet expansion downstream of the inlet aperture. The supersonic free jet expansion comprises a barrel shock of predetermined diameter and a Mach disc, the free jet expansion entraining the ions and carrying them into the vacuum chamber. In various aspects, the apparatus also comprises at least one ion guide with a predetermined cross-section defining an internal volume wherein the cross-section of the at least one ion guide is sized to be at least 50% of the predetermined diameter of the barrel shock of the supersonic free jet expansion. The at least one ion guide can be positioned in the chamber between the inlet aperture and an exit aperture so that when an RF voltage, supplied by a RF power supply, is applied to the at least one ion guide, the ions in the supersonic free jet can be radially confined within the internal volume of the at least one ion guide and focused and directed to the exit aperture. In various aspects, radial gas conductance can be reduced in a first section of the at least one ion guide for damping shock waves resulting from the supersonic fee jet expansion. In various embodiments, an insulating sleeve for reducing radial gas conductance can be provided surrounding at least a first portion of the length of the at least one ion guide for damping shock waves resulting from the supersonic free jet expansion.

In various aspects, there is provided a mass spectrometer comprising an ion source for generating ions from a sample in a high-pressure region, for example, at atmospheric pressure, and a vacuum chamber for receiving the ions. The vacuum chamber has an inlet aperture for passing the ions from the high-pressure region into the vacuum chamber. The vacuum chamber also has an exit aperture for passing ions from the vacuum chamber wherein the configuration of the inlet aperture and the pressure difference between the high pressure region and the vacuum chamber provides a supersonic free jet expansion downstream of the inlet aperture. The supersonic free jet expansion comprises a barrel shock of predetermined diameter and a Mach disc, the free jet expansion entraining the ions and carrying them into the vacuum chamber. In various aspects, the apparatus also comprises at least one ion guide between the inlet and exit apertures, the at least one ion guide having a predetermined cross-section defining an internal volume wherein the cross-section of the at least one ion guide is sized to be at least 50% of the predetermined diameter of the barrel shock of the supersonic free jet expansion. The at least one ion guide comprising at least one multipole ion guide having a plurality of elongated electrodes wherein the spacing between the elongated electrodes is reduced to a distance of less than 0.2R₀, wherein R₀ is the radius of the inscribed circle between the electrodes. A power supply can be provided for providing an RF voltage to the at least one ion guide for radially confining the ions within the internal volume of the at least one ion guide.

In various embodiments, there is provided a system for performing mass analysis comprising an ion source for generating ions from a sample in a high pressure region. In various embodiments, the ions can pass into a vacuum chamber comprising an inlet aperture for passing the ions from the high-pressure region into the vacuum chamber, and an exit aperture for passing ions from the vacuum chamber, wherein the configuration of the inlet aperture and the pressure difference between the high pressure region and the vacuum chamber provides a supersonic free jet expansion downstream of the inlet aperture, the supersonic free jet expansion comprising a barrel shock of predetermined diameter. In various aspects, at least one higher order multipole ion guide can be between the inlet and exit apertures, the at least one ion guide comprising wires and a power supply for applying an RF voltage to the at least one ion guide for radially confining the ions within the internal volume of the at least one ion guide wherein opposite RF phases are applied between adjacent wires.

The applicant's teachings also provide a method for performing mass analysis. The method comprises generating ions from a sample in a high-pressure region, for example, at atmospheric pressure, and passing ions into a vacuum chamber positioned downstream of the ion source for receiving the ions. The vacuum chamber is provided with an inlet aperture for passing the ions from the high-pressure region into the vacuum chamber and an exit aperture for passing ions from the vacuum chamber. The configuration of the inlet aperture and the pressure difference between the high pressure region and the vacuum chamber provides a supersonic free jet expansion downstream of the inlet aperture. The supersonic free jet expansion has a barrel shock of predetermined diameter and a Mach disc. The ions, which pass through the inlet aperture, are entrained by the supersonic free jet expansion created in the vacuum chamber. The method further comprises providing at least one ion guide between the inlet and exit apertures. In various aspects, the at least one ion guide can have a predetermined cross-section defining an internal volume. In various embodiments, the at least one ion guide can be sized to radially confine the supersonic free jet expansion so as to capture essentially all of the ions, and the at least one ion guide is sized to be at least 50% of the predetermined diameter of the barrel shock of the supersonic free jet expansion. The method further comprises applying an RF voltage to the at least one ion guide for radially confining the ions within the internal volume of the at least one ion guide. In various aspects, the method also comprises reducing radial gas conductance in a first section of the at least one ion guide for damping shock waves resulting from the supersonic free jet expansion.

In various aspects, there is provided a method comprising providing an ion source for generating ions from a sample in a high-pressure region, for example, at atmospheric pressure, and a vacuum chamber for receiving the ions. The vacuum chamber has an inlet aperture for passing the ions from the high-pressure region into the vacuum chamber. The vacuum chamber also has an exit aperture for passing ions from the vacuum chamber wherein the configuration of the inlet aperture and the pressure difference between the high pressure region and the vacuum chamber provides a supersonic free jet expansion downstream of the inlet aperture. The supersonic free jet expansion comprises a barrel shock of predetermined diameter and a Mach disc, the free jet expansion entraining the ions and carrying them into the vacuum chamber. In various aspects, the method also comprises providing at least one ion guide between the inlet and exit apertures, the at least one ion guide having a predetermined cross-section defining an internal volume wherein the cross-section of the at least one ion guide is sized to be at least 50% of the predetermined diameter of the barrel shock of the supersonic free jet expansion. The at least one ion guide comprising at least one multipole ion guide having a plurality of elongated electrodes wherein the spacing between the elongated electrodes is reduced to a distance of less than 0.2R₀, wherein R₀ is the radius of the inscribed circle between the electrodes. A power supply can be provided for providing an RF voltage to the at least one ion guide for radially confining the ions within the internal volume of the at least one ion guide.

In various embodiments, there is provided a method for performing mass analysis comprising providing an ion source for generating ions from a sample in a high pressure region. In various embodiments, the ions can pass into a vacuum chamber comprising an inlet aperture for passing the ions from the high-pressure region into the vacuum chamber, and an exit aperture for passing ions from the vacuum chamber, wherein the configuration of the inlet aperture and the pressure difference between the high pressure region and the vacuum chamber provides a supersonic free jet expansion downstream of the inlet aperture, the supersonic free jet expansion comprising a barrel shock of predetermined diameter. In various aspects, there is provided at least one higher order multipole ion guide between the inlet and exit apertures, the at least one ion guide comprising wires and providing a power supply for applying an RF voltage to the at least one ion guide for radially confining the ions within the internal volume of the at least one ion guide wherein opposite RF phases are applied between adjacent wires.

These and other features of the applicant's teachings are set forth herein.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1A is a schematic view of a mass spectrometer according to various embodiments of the applicant's teachings;

FIG. 1B is a cross-sectional view of an ion guide of the embodiment of FIG. 1A according to various embodiments of the applicant's teachings;

FIG. 2 is a schematic view of the supersonic free jet expansion according to various embodiments of the applicant's teachings.

FIG. 3 is a cross-sectional view of an ion guide according to various embodiments of the applicant's teachings;

FIG. 4 schematically illustrates an ion guide according to the applicant's teachings and shows a cross-sectional view of the ion guide according to various embodiments of the applicant's teachings;

FIG. 5 schematically illustrates an ion guide according to the applicant's teachings and shows a cross-sectional view of the ion guide according to various embodiments of the applicant's teachings;

FIG. 6 schematically illustrates a series of ion guides according to the applicant's teachings and shows cross-sectional views of the series of ion guides according to various embodiments of the applicant's teachings;

FIG. 7 schematically illustrates an ion guide and shows cross-sectional views of the ion guide according to various embodiments of the applicant's teachings;

FIG. 8 schematically illustrates an ion guide according to various embodiments of the applicant's teachings;

FIG. 9 schematically illustrates an end and a side view of an ion guide according to various embodiments of the applicant's teachings;

FIG. 10 schematically illustrates an ion guide according to various embodiments of the applicant's teachings;

FIG. 11 schematically illustrates an ion guide according to various embodiments of the applicant's teachings.

In the drawings, like reference numerals indicate like parts.

### DESCRIPTION OF VARIOUS EMBODIMENTS

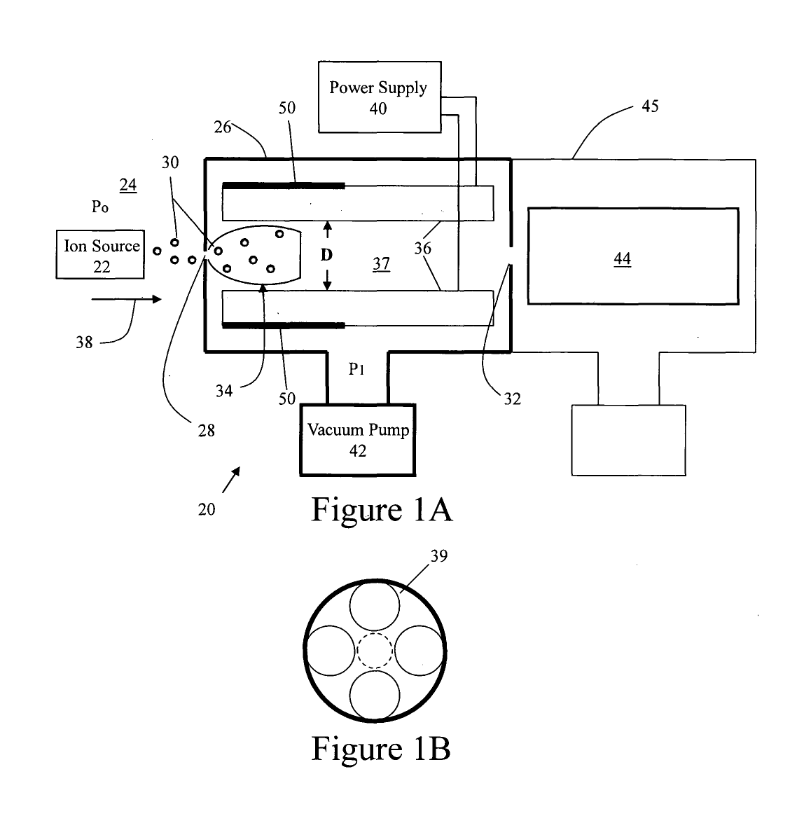

It should be understood that the phrase “a” or “an” used in conjunction with the applicant's teachings with reference to various elements encompasses “one or more” or “at least one” unless the context clearly indicates otherwise. A method and apparatus for performing mass analysis is provided. Reference is first made to FIG. 1A, which shows schematically a mass spectrometer, generally indicated by reference number 20. The mass spectrometer 20 comprises an ion source 22 for generating ions 30 from a sample of interest, not shown. The ion source 22 can be positioned in a high-pressure P0 region containing a background gas (not shown), generally indicated at 24, while the ions 30 travel towards a vacuum chamber 26, in the direction indicated by the arrow 38. The ions enter the chamber 26 through an inlet aperture 28, where the ions are entrained by a supersonic flow of gas, typically referred to as a supersonic free jet expansion 34 as described, for example, in applicant's U.S. Pat. Nos. 7,256,395 and 7,259,371 herein incorporated by reference. The vacuum chamber 26 further comprises an exit aperture 32 located downstream from the inlet aperture 28 and at least one ion guide 36 positioned between the apertures 28, 32 for radially confining, focusing and transmitting the ions 30 from the supersonic free gas jet 34. In various aspects, the rods of the at least one multipole ion guide 36 can comprise circular elongated electrodes 39 as shown in FIG. 1B. The exit aperture 32 in FIG. 1A is shown as the inter-chamber aperture separating the vacuum chamber 26, also known as the first vacuum chamber 26, from the next or second vacuum chamber 45 that may house additional ion guides or a mass analyzer 44. Typical mass analyzers 44 in the applicant's teachings can include quadrupole mass analyzers, ion trap mass analyzers (including linear ion trap mass analyzer) and time-of-flight mass analyzers. The pressure P1 in the vacuum chamber 26 can be maintained by pump 42, and power supply 40 can be connected to the at least one ion guide 36 to provide RF voltage in a known manner. The at least one ion guide 36 can be a set of quadrupole rods with a predetermined cross-section, as shown in FIG. 1B, characterized by an inscribed circle with a diameter as indicated by reference letter D extending along the axial length of the at least one ion guide 36 to define an internal volume 37. In various aspects, the diameter D can vary along the length of the ion guide. In various embodiments, the at least one ion guide can have a predetermined cross-section defining an internal volume; wherein the cross-section of the at least one ion guide is sized to be at least 50% of the predetermined diameter of the barrel shock of the supersonic free jet expansion. The ions 30 can initially pass through an orifice-curtain gas region generally known in the art for performing desolvation and blocking unwanted particulates from entering the vacuum chamber.

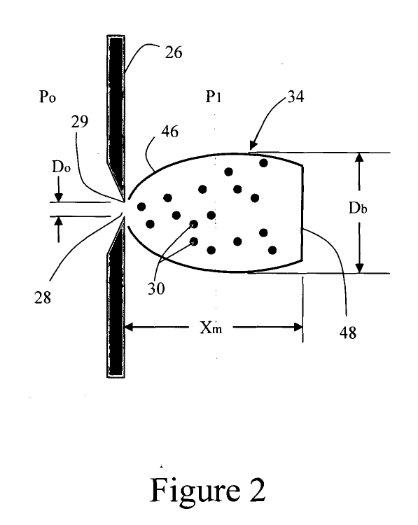

As shown in FIG. 2, the supersonic free jet expansion downstream of the inlet aperture 28 can comprise a barrel shock of predetermined diameter. The expansion comprises a concentric barrel shock 46 and terminated by a perpendicular shock known as the Mach disc 48. As the ions 30 enter the vacuum chamber 26 through the inlet aperture 28, they are entrained in the supersonic free jet 34 and since the structure of the barrel shock 46 defines the region in which the gas and ions expand, virtually all of the ions 30 that pass through the inlet aperture 28 are confined to the region of the barrel shock 46. It is generally understood that the gas downstream of the Mach disc 48 can re-expand and form a series of one or more subsequent barrel shocks and Mach discs that are less well-defined compared to the primary barrel shock 46 and primary Mach disc 48.

The supersonic free jet expansion 34 can be generally characterized by the barrel shock diameter Db, typically located at the widest part as indicated in FIG. 2, and the downstream position Xm of the Mach disc 48, as measured from the inlet aperture 28, more precisely, from the throat 29 of the inlet aperture 28 producing the sonic surface. The Db and Xm dimensions can be calculated from the size of the inlet aperture, namely the diameter Do, the pressure at the ion source P0 and from the pressure P1 in the vacuum chamber, as known in the art. In various aspects, to achieve high sensitivity, the inlet aperture can be increased. However, with a larger inlet aperture, for example, with an inlet aperture with a diameter greater than about 0.6 mm, gas dynamics and shock waves can affect ion focusing which can reduce sensitivity. The presence of shock waves in the chamber can be observed by measuring the pressure in the second vacuum chamber 45 as a function of the pressure in the first chamber 26, and by measuring the ion signal in the mass spectrometer as a function of the pressure in the first chamber. Shock waves can be indicated by sudden non-linear changes in pressure and in ion signal intensity as the pressure is changed. A small increase in pressure can cause the ion signal to decrease sharply, an indication of the presence of a shock wave that affects the ion focusing and transmission. This effect is undesirable because a small change in vacuum pressure can cause a large decrease in sensitivity. The applicants have found that the shock waves are produced by interaction between the supersonic free jet and the ion guide electrodes. The applicants have found that a method and apparatus for providing reduced gas conductance in a radial direction in a first section of the at least one ion guide can damp out shock waves and can provide a more predictable and controlled pressure field and ion flow. The applicants have also found that increasing the radial gas conductance so that the electrodes do not interact with or interfere with or impede the free jet expansion, can also reduce or eliminate the shock waves.

In various embodiments, an insulating sleeve 50, as shown in FIG. 1, can be used for reducing radial gas conductance. In various aspects, the sleeve can surround at least a first portion of the at least one ion guide 36 for damping shock waves resulting from the supersonic free jet expansion.

In various aspects, the sleeve can comprise at least the length of the supersonic free jet expansion. In various embodiments, the length of the sleeve can comprise between about 5 mm and about 30 mm. In various embodiments, the diameter of the sleeve can comprise approximately the outside diameter of the at least one ion guide. In various aspects, the sleeve can comprise an insulating material. In various aspects, the sleeve can comprise a teflon sleeve.

In various embodiments, the at least one ion guide comprises at least one multipole having a plurality of elongated electrodes. In various aspects, the at least one multipole ion guide can comprise a quadrupole having four elongated electrodes, a hexapole ion guide having six elongated electrodes, an octapole ion guide having eight elongated electrodes or higher number of poles or any combination thereof. In various embodiments, the at least one ion guide can comprise a series of multipole ion guides. In various aspects, the series of multipole ion guides can include quadrupole, hexapole, octapole, or higher number of poles. The poles can be elongated electrodes carrying the RF voltages generally known in the art. Other configurations containing greater numbers of poles, or electrodes of different shapes, are also possible. For example, the electrodes can comprise wires or rods and can be square or flat instead of circular in cross section, or the electrodes can have cross sections that vary along the elongated length. In various embodiments, the poles can be multiple electrode segments connected to corresponding power supplies to provide differential fields between adjacent segments. In various embodiments, the at least one ion guide can comprise a ring ion guide or ion funnel with decreased radial gas conductance between the rings.

In various embodiments, the inlet aperture can be circular and can comprise a diameter between about 0.1 mm and about 2 mm. In various aspects, the circular inlet aperture can comprise a diameter of about 0.7 mm.

In various embodiments, the predetermined cross section of the at least one ion guide can form an inscribed circle and can comprise a diameter between about 3 mm and about 15 mm.

In various aspects, the vacuum chamber can comprise a pressure between about 1 torr and about 20 torr. In various embodiments, the vacuum chamber can comprise a pressure of about 3 torr.

In various embodiments, a method and apparatus for providing reduced radial gas conductance in a first section of the at least one ion guide that can damp out expanding shock waves can comprise at least one ion guide comprising at least one multipole ion guide having a plurality of elongated electrodes wherein the spacing between the elongated electrodes can be reduced to a distance of less than 0.8R₀/n wherein R₀ is the radius of the inscribed circle between the electrodes and n is the number of electrodes. In various aspects, an ion source can be provided for generating ions from a sample in a high pressure region. In various embodiments, there can be method and apparatus in which there is provided a vacuum chamber comprising an inlet aperture for passing the ions from the high-pressure region into the vacuum chamber, and an exit aperture for passing ions from the vacuum chamber; wherein the configuration of the inlet aperture and the pressure difference between the high pressure region and the vacuum chamber provides a supersonic free jet expansion downstream of the inlet aperture, the supersonic free jet expansion comprising a barrel shock of predetermined diameter. In various aspects, there can be provided at least one ion guide between the inlet and exit apertures, the at least one ion guide having a predetermined cross-section defining an internal volume, wherein the cross-section of the at least one ion guide is sized to be at least 50% of the predetermined diameter of the barrel shock of the supersonic free jet expansion. The at least one ion guide can comprise at least one multipole ion guide having a plurality of elongated electrodes wherein the spacing between the elongated electrodes is reduced to a distance of less than 0.2R₀, and wherein R₀ is the radius of the inscribed circle between the electrodes. In various embodiments, there can be provided a power supply that can provide an RF voltage to the at least one ion guide for radially confining the ions within the internal volume of the at least one ion guide. In various aspects, the at least one multipole ion guide can be selected from a quadrupole ion guide having four elongated electrodes, a hexapole ion guide having six elongated electrodes, and an octapole ion guide having eight elongated electrodes, and any combination thereof. In various aspects, the rods of the at least one multipole ion guide are selected from one of oblate elongated electrodes and circular elongated electrodes. In various aspects, the spacing between the elongated electrodes comprises between about 0.4 mm and about 1.5 mm. In various embodiments, the spacing between the elongated electrodes can be maintained for a distance of at least about 5 cm along the length of the at least one ion guide. In various aspects, the elongated electrodes comprise protuberances. In various aspects, the protuberances comprise a width that is less than approximately half the width of the rods in the longest dimension perpendicular to the longitudinal axis, and more than about 1 mm in height. In various aspects, the at least one multipole ion guide comprises a series of multipole ion guides. In various aspects, the inlet aperture is circular and has a diameter between about 0.1 and about 2 mm. In various aspects, the circular inlet aperture comprises a diameter of about 0.7 mm. In various aspects, the predetermined cross-section forms an inscribed circle and has a diameter is between about 3 and about 15 mm. In various aspects, the vacuum chamber has a pressure between about 1 and about 20 torr. In various aspects, the vacuum chamber has a pressure of about 3 torr. In various aspects, the at least one ion guide comprises a first ion guide followed by a second ion guide wherein the second ion guide comprises a smaller diameter than the first ion guide. In various aspects, the second ion guide comprises electrodes with inner surfaces that tilt toward the axis in the direction of ion flow. In various aspects, the diameter of the inscribed circle within the second ion guide is about 4 mm at the entrance and about 2 mm at the exit.

In various embodiments, the multipole can comprise a quadrupole and the spacing between the elongated electrodes can comprise between about 0.4 mm and about 1.5 mm. In various aspects, the spacing between the elongated electrodes can be maintained for a distance of at least about 5 cm along the length of the at least one ion guide.

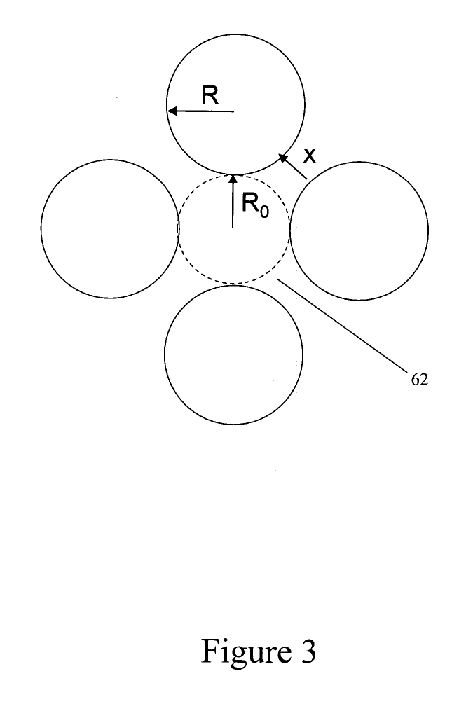

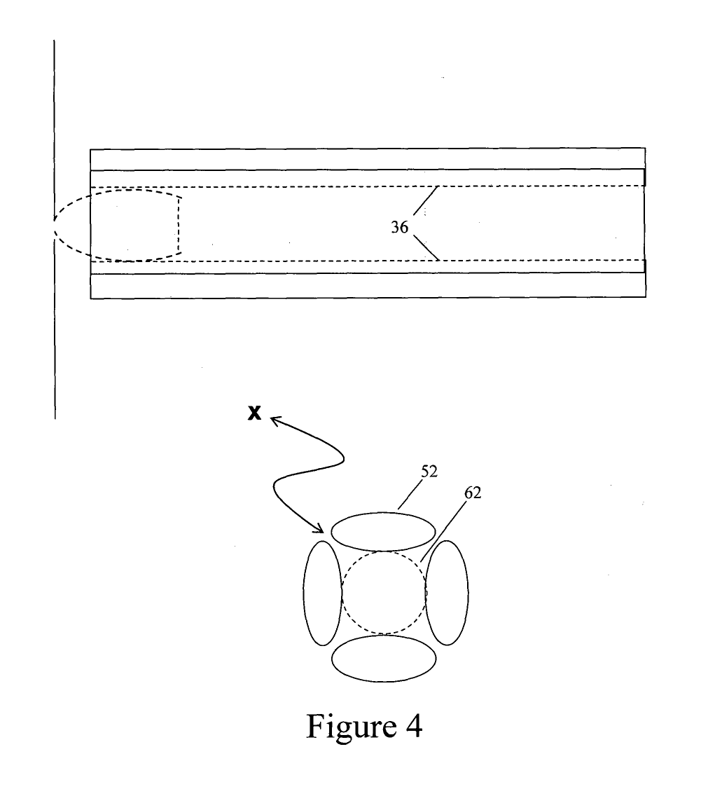

In various embodiments, the rods of the at least one multipole ion guide can comprise circular elongated electrodes as shown in FIG. 3. In FIG. 3, R is the radius of the elongated electrodes, R₀ is the radius of the inscribed circle 62 between the electrodes, or the distance between the central axis of the quadrupole and the inner surface of the electrode, and x is the gap or spacing between the elongated electrodes. In various embodiments, the spacing between the circular elongated electrodes of a quadrupole can be reduced to a distance of less than 0.2R₀. In various aspects, the rods of the at least one multipole ion guide 36 can comprise oblate elongated electrodes 52 as shown in FIG. 4.

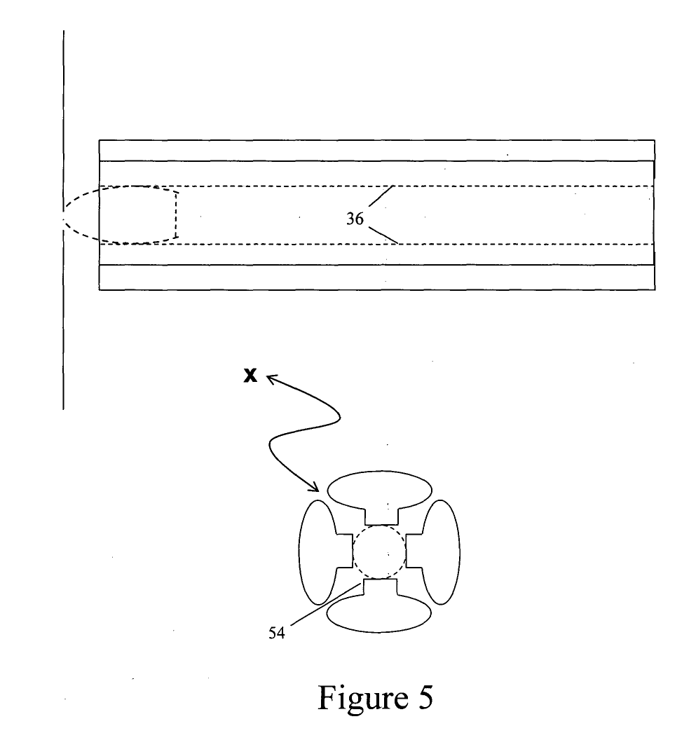

In various aspects, the elongated electrodes comprise protuberances 54, as shown in FIG. 5. In various embodiments, the protuberances comprise a width that is less than approximately half the width of the rods in the longest dimension perpendicular to the longitudinal axis and more than about 1 mm in height. The protuberances can provide increased electric field strength for better ion focusing.

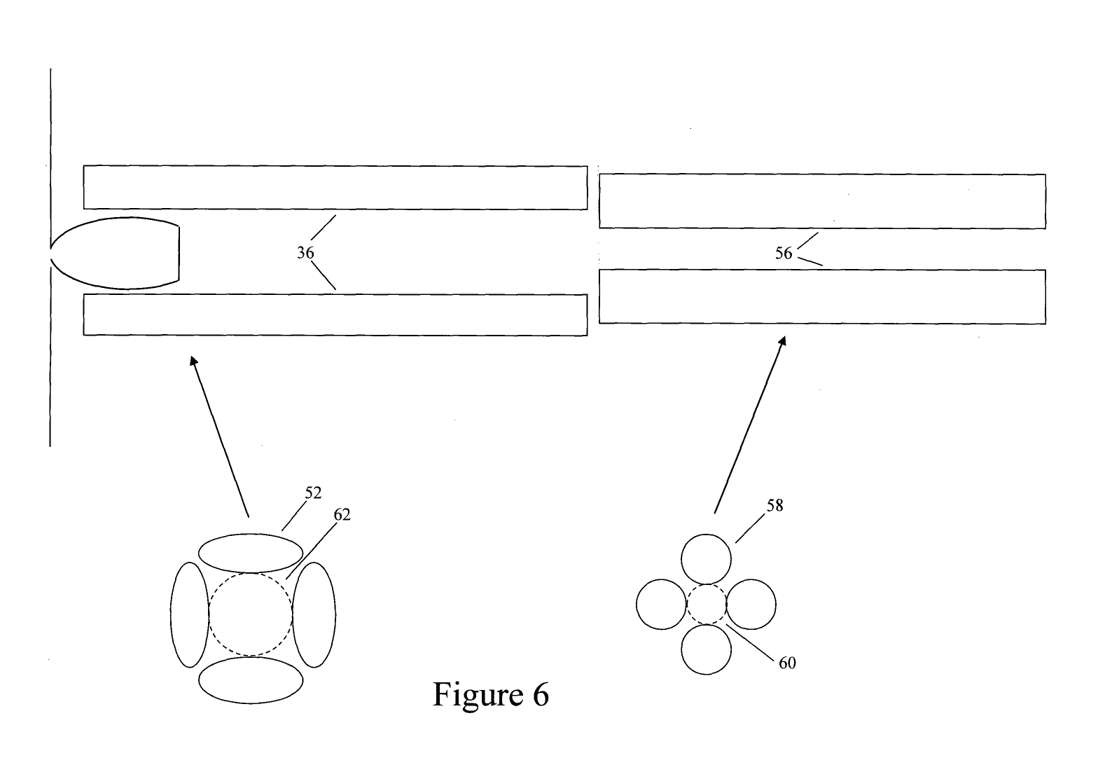

In various embodiments, the at least one ion guide comprises a first ion guide 36 followed by a second ion guide 56 wherein the second ion guide comprises a smaller diameter than the first ion guide as shown in FIG. 6. FIG. 6 shows, for example, the first ion guide comprising oblate quadrupole electrodes 52, and the second ion guide 56 comprising circular quadrupole electrodes 58, but any combinations of numbers of poles and shapes are possible.

In various aspects, the second ion guide can comprise electrodes with inner surfaces that tilt toward the axis in the direction of ion flow. In various embodiments, the diameter of the inscribed circle 60 within the second ion guide comprises about 4 mm at an entrance end and about 2 mm at an exit end.

In various embodiments, the inlet aperture can be circular and can comprise a diameter between about 0.1 mm and about 2 mm. In various aspects, the circular inlet aperture can comprise a diameter of about 0.7 mm.

In various embodiments, the predetermined cross section of the at least one ion guide can form an inscribed circle and can comprise a diameter between about 3 mm and about 15 mm. In various embodiments, the predetermined cross-section of the at least one ion guide can form an inscribed circle and can comprise a diameter of about 7 mm.

In various aspects, the vacuum chamber can comprise a pressure between about 1 torr and about 20 torr. In various embodiments, the vacuum chamber can comprise a pressure of about 3 torr.

In various embodiments, a method and apparatus are provided comprising an ion guide having a cylindrical surface comprised of pins or elongated electrodes facing inward, with alternate RF phases along radial surfaces and along the axial surface of the cylinder, presenting a pincushion effect and an RF field that is strong near the surface and weaker toward the center. The pseudo-force from the gradient of the RF field (˜∇E²) can be strong, counteracting gas drag outward. In various aspects, the geometry can allow simplified construction that can avoid the need for using insulators between each pin. In various embodiments, the geometry can allow the possibility of providing a strong RF and moderately smooth RF surface near the entrance where ions need to be confined, moving to a quadrupolar field geometry near the exit that can provide better focusing toward the axis. The geometry can provide an axial field by displacement of one set of pins toward the axis. It also can allow for tapering of the field inward that can provide a funnelling effect.

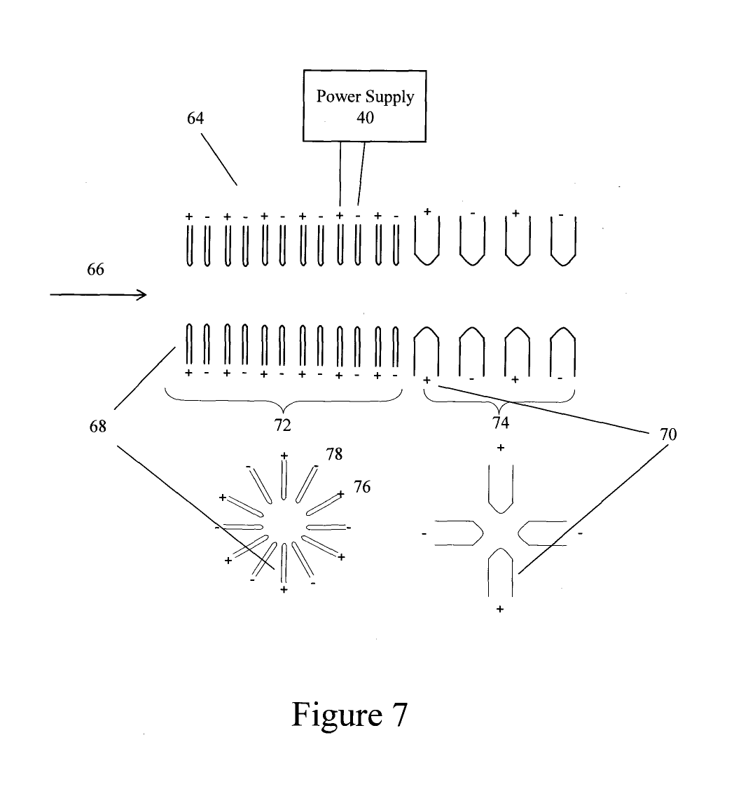

Reference is made to FIG. 7 which exemplifies various embodiments of the applicant's teachings. A pin ion guide 64 is generally shown in a longitudinal cross-sectional view in FIG. 7. Ions enter the front of the ion guide as shown by direction 66. The bottom of FIG. 7 shows a transverse cross section of the first part of the guide 72, comprised of twelve pins disposed around the circumference of a circle. An RF power supply 40 is connected to provide RF voltage of opposite phases, generally indicated as positive, “+”, and negative, “−”, to adjacent pins 76 and 78 as shown, with all pins indicated as positive, “+”, connected together, and all pins indicated as negative, “−”, connected together. The twelve pins with the RF voltage produce a radial dodecapole field around the circumference. In the first part of the guide 72, the RF phases of opposite polarity or opposite phase (i.e., 180° out of phase) is also applied between axially adjacent pins as shown in the top of FIG. 7, as well as between radially adjacent pins as described above and shown in the bottom of FIG. 7, providing, axial and radial RF fields. In the second part of the guide 74, comprising 4 pins around the circumference, the same polarity between adjacent axial pins can be maintained so that axially aligned pins can be of the same polarity which can provide a more pure quadrupole field. In various configurations, opposite phases can be applied between adjacent pins in the axial direction

In various embodiments, a 12-pin configuration can be maintained along the entire length. In various aspects, a configuration with 8n+4 pins around the circumference can be maintained along at least part of the length, where n=1, 2, 3 . . . . , etc. In various configurations, the internal shape formed by the pins of the ion guide may be oblate or rectangular rather than circular as shown, in order to accommodate ion beam shapes that are not circular, or to form an exit beam that is not circular.

In various aspects, a tapered geometry can be applied to any configuration, making the radial spacings decrease toward the exit to provide focusing.

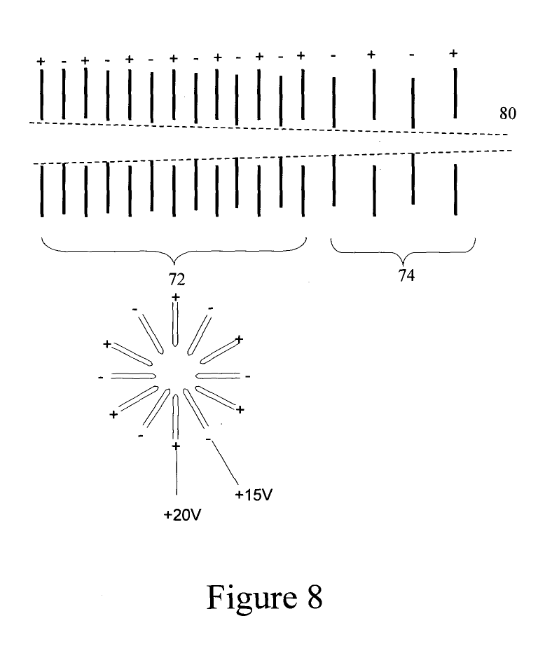

To provide an axial field, one set of pins to which one RF phase can be applied can project slightly further into the space. Combined with a different DC voltage on that set of pins, an axial field can be generated, as shown in FIG. 8. Pins of one phase can project further toward the axis, with the amount of projection increasing along the axis, as generally shown by dotted line 80. A different DC voltage can be provided to each of the two sets of pins [positive (+) and negative (−) RF phase] as shown in the example at the bottom of FIG. 8 where +20V is applied to the positive set of pins and +15V is applied to the negative set of pins. This can provide an axial electric field. The axial field strength can be adjusted by controlling the angle of projection of the pins (the angle of dotted line 80) and the difference in DC potential between the two set of pins.

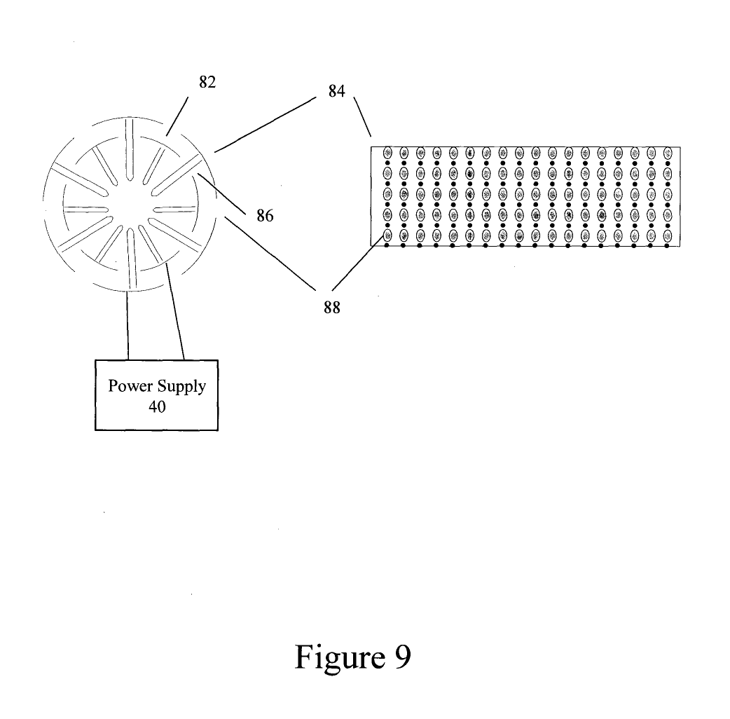

In various aspects, support for the two sets of pins for each phase can be provided by two coaxial cylinders with appropriately positioned holes as shown in FIG. 9. FIG. 9 shows an end view, on the left, and a side view, on the right, of cylindrical support for the pins. The inner cylinder 82 can have clearance holes 86 for pins to pass through. The outer cylinder 84 can have clearance holes 88 to allow inner pins to be installed. Positions and configurations of the pins can be defined by the hole pattern in the cylinders and by the length of the pins.

In various embodiments, the two cylindrical supports can be spaced with insulators that are well away from the ion path. Individual resistors and capacitors can be incorporated if explicit DC gradients produced by resistive dividers along the axis are necessary to produce an axial field. However, the geometrical production of an axial field can be sufficient.

In various aspects, the ion guide can look like a pin cushion on the inside. Spacing and positioning of pins can be optimized experimentally or through simulation. In various aspects, the diameters of the small pins in the front section of the ion guide can be 0.5 mm in diameter. In various aspects, the diameters of the large pins can be 2 mm in diameter.

When ions are sampled from an atmospheric pressure ion source through an aperture into vacuum, they expand in a high velocity diverging gas jet from which they must be extracted and focused. Larger orifice diameters provide higher ion flux, but also cause higher gas pressures and therefore more drag on the ions, which must be overcome to focus the ions. Additionally, larger orifice diameters make it more difficult to avoid introducing contaminants, clusters, particles and droplets into the vacuum chamber. These impurities can precipitate on the RF ion guide elements and lenses, causing insulating layers that can charge up, resulting in loss of sensitivity. It is desirable to provide strong containment and focusing to extract ions from a diverging gas flow, allowing the gas to be pumped away radially, while confining and focusing the ions axially. It is also desirable to produce strong containment electric fields without introducing electrode surfaces that can restrict the gas flow, and that can become contaminated with impurities.

The applicant's teachings provide a method and an apparatus comprising of an RF ion guide having small diameter electrodes. In various aspects, the electrodes can be thin wires. In various embodiments, the thin wires can be about 0.01 mm to about 0.5 mm in diameter. Such small diameters intersect a smaller portion of the flow, and less entrained material such as droplets and particles will precipitate on the electrodes. Additionally, any material that does precipitate and become charged up, can have less influence on the ion motion because of the relative value of the surface-charge induced field compared to the applied voltage. The smaller the surface area of the electrode, the less influence of the surface charge. This improvement can be derived from the increase in the ratio of the area between the electrodes, compared to the electrode surface area.

A quadrupole formed of 4 wires may not be sufficient to provide an effective containment field because the electric field (for the same voltage on the wires) is too weak. To some degree this can be mitigated by increasing the voltage on the wires, but in the regions that are farther from the axis, the field may be too weak. The applied voltage should not be so high as to cause a discharge or arcing, which can occur at a voltage above 300V or 400V at a pressure of 1 torr. Increasing the number of wires around the same diameter of inscribed circle can increase the containment field. A larger number of wires, with opposite RF phases between adjacent wires, can produce a higher order multipole field. For example, it can contain, but is not limited to, 12 wires, located on the same inscribed circle. A wire multipole with sufficient number of wires or small diameter can provide a small surface area allowing gas and particles to escape, but can still provide sufficiently strong electric fields to contain the ions within the ion guide. Therefore, a high order multipole comprising 12 or up to 100 wires can provide a strong containment field for the ions, while presenting a small surface area that does not impede the gas flow and does not become contaminated.

A high order multipole typically cannot provide strong focusing to a small beam diameter. To achieve this, the ideal geometry is a quadrupolar field. Therefore, the multipole can be made to transition smoothly to a smaller diameter quadrupole. The strong containment provided by a high order multipole can be required near the front of the ion guide, where the gas pressure and velocity is high. As the ions are thermalized and the gas density and velocity drops, the need for strong radial containment decreases, and a quadrupole field can provide ion focusing.

In various embodiments, there is provided a method and system for performing mass analysis comprising providing an ion source for generating ions from a sample in a high pressure region. In various embodiments, the ions can pass into a vacuum chamber comprising an inlet aperture for passing the ions from the high-pressure region into the vacuum chamber, and an exit aperture for passing ions from the vacuum chamber, wherein the configuration of the inlet aperture and the pressure difference between the high pressure region and the vacuum chamber provides a supersonic free jet expansion downstream of the inlet aperture, the supersonic free jet expansion comprising a barrel shock of predetermined diameter. In various aspects, there is provided at least one higher order multipole ion guide between the inlet and exit apertures, the at least one ion guide comprising wires and a power supply for applying an RF voltage to the at least one ion guide for radially confining the ions within the internal volume of the at least one ion guide wherein opposite RF phases are applied between adjacent wires. In various aspects, the wire multipole ion guide converges toward the exit from the vacuum chamber to form a multipole ion guide of lower order than that formed near the entrance of the vacuum chamber. In various embodiments, the lower order multipole ion guide comprises a quadrupole. In various aspects, the supersonic free jet expansion can be directed at an angle to the axis of the wire multipole ion guide. In various embodiments, the angle between the supersonic free jet expansion and the axis of the wire multipole ion guide can be between about 1 degree and about 10 degrees. In various aspects, the plane of the aperture can be tilted in order to direct the free jet at an angle to axis of the multipole ion guide. In various embodiments, the diameter of the wires in the wire multipole ion guide can be about 0.01 mm to about 0.5 mm.

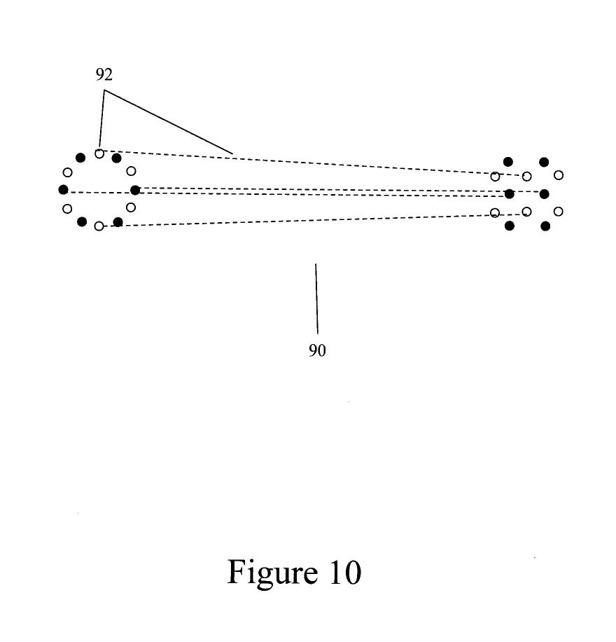

In various aspects, the applicant's teachings comprise a wire ion guide that begins as a higher-order multipole and smoothly transitions to a quadrupole. The applicant's teachings can provide stronger containment for sampling ions at the front of the ion guide and a smooth transition to a quadruple at the exit that can focus the ions more strongly. As exemplified in FIG. 10, showing ion guide 90, twelve wires 92 form a dodecapole near the entrance, shown in cross-section transverse to the axis in the left part of FIG. 10. The solid set of circles represent the set of six wires that are connected to the positive (+) phase of an RF power supply (not shown), and the set of gray shaded circles represent the set of six wires connected to the negative (−) phase of the RF power supply. In some configurations, four of the wires can converge smoothly toward the exit as shown by the two dotted lines representing two of the wires (the other two wires are not shown in this view), forming a quadrupolar field near the exit. The other eight wires can be parallel to the axis. Only two of the twelve wires are shown in FIG. 10, it being understood that the wires connect the entrance and exit representations of the positions of the wires at the entrance and exit. The configuration shown in FIG. 10 results in a dodecapole field near the entrance and a quadrupole field near the exit. The ion beam can be focused toward the exit by this configuration.

In various embodiments, multiple number of wires can be used near the entrance. For example, in various aspects, 12, 20, 28, etc. up to 100 wires or even more can be near the entrance. In various embodiments, the applicant's teachings can also comprise a converging multipole, with all wires converging toward the exit. In various embodiments, some of the wires can converge toward the exit to form a multipole of lower order than that formed near the exit, while the other wires remain parallel to the axis, or else terminate before reaching the end of the multipole. In various aspects, the cross-section may be oval or rectangular or of another shape other than circular to accommodate different beam shapes at the entrance or exit.

In various aspects, the applicant's teachings can comprise a wire multipole in a free jet expansion. In various embodiments, the wire diameter can be about <0.5 mm to about 0.01 mm. In various embodiments, the applicant's teachings can comprise a higher order multipole converging smoothly to a quadrupole field. In various aspects, the applicant's teachings can comprise a wire multipole disposed at an angle to the gas jet in order to capture and steer the ions out of the gas jet without interrupting the gas flow.

In various embodiments, the wire multipole can be formed in a curved or bent shape so that the ion beam is steered off axis by an angle of between about 10 degrees and about 90 degrees. The wire structure can let the neutral beam proceed without restriction, while the ions are bent out of the gas flow. In various aspects, this configuration can help to protect the ion lens located at the exit from the ion guide from becoming contaminated. In various embodiments, the applicant's teachings can comprise the use of a curved wire multipole in a free jet. In various aspects, the applicant's teachings can comprise the combination of a multipole converging to a quadrupole.

In various embodiments, the applicant's teachings can comprise reducing the effect of contamination on the ion lens by providing a mesh in front of the lens. Most contamination can go through the mesh to the lens. The voltage on the mesh can provide the optimum field on the upstream side relative to the ion guide. Between the mesh and the lens a small voltage can be provided to a) pull ions through the mesh and b) to overcome the effect of contamination on the lens. The mesh/lens element can be provided at the end of an ion guide sampling ions from atmospheric pressure.

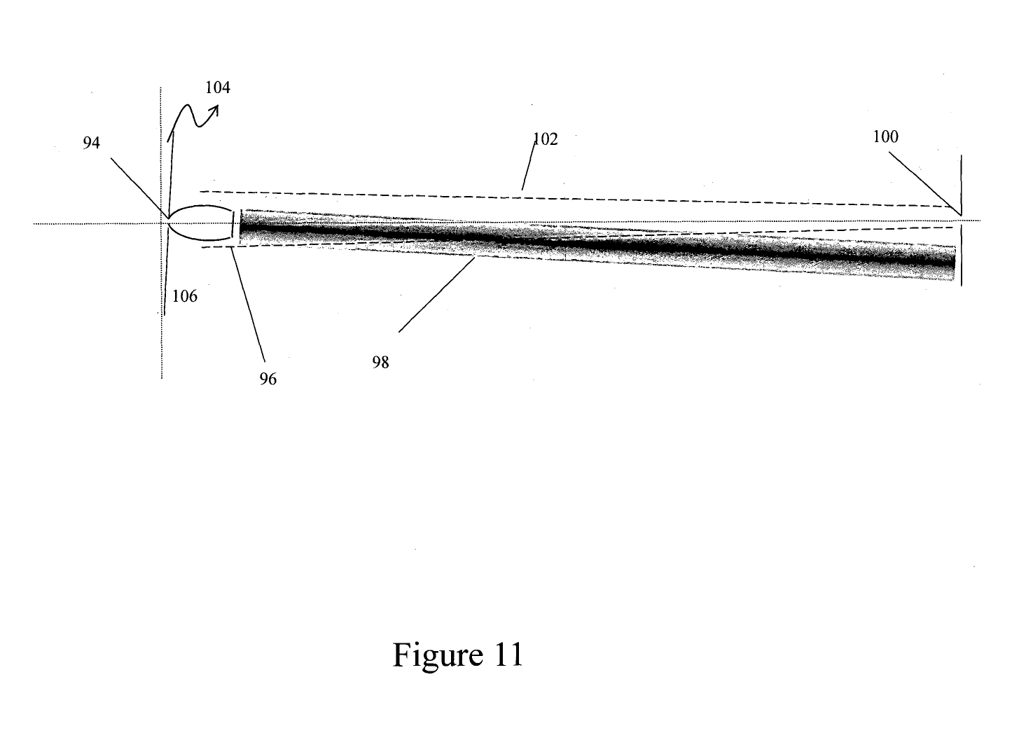

One of the problems associated with focusing ions from a free jet expanding into vacuum, is that a strong gas jet can be formed downstream of the Mach disc, the velocity of the gas jet being several hundred meters per second. This reduces the transit time of ions through the ion guide, and can inhibit the focusing of the ions. The gas jet can also impact on the exit aperture causing more gas to enter the following vacuum chamber, requiring more or larger vacuum pumps in the next chamber. In order to reduce the impact of the gas jet issuing from the orifice, and remove ions from the jet into a more quiescent region of static gas where the gas velocity is lower and the gas density is lower, so that the ions can be better focused, the jet from an aperture can be directed at an angle to the main axis of the ion guide as shown in FIG. 11. The gas expanding through aperture 94 in plate 106 leading from a high pressure ion source such as electrospray or APCI into vacuum, forms a free jet 96 as is known in the art, and also forms a stream or directed jet of gas 98 that extends far beyond the free jet. A longer and more intense jet of gas is generally formed by a larger orifice. The size and extent of the gas jet is also affected by the pressure in the vacuum chamber. The gas jet 96 formed from the free jet 94 can then be directed away from the aperture 100 that leads to the next vacuum chamber. The ions can then be more efficiently contained and focused within the RF ion guide. In various aspects, the applicant's teachings can comprise a wire multipole that is nearly transparent to the gas flow, comprising of fine wires or small diameter electrodes generally indicated by dotted lines 102, where it is understood that only two of the wires are shown by the dotted lines, with opposite RF phases applied between adjacent wires. In various embodiments, the inscribed diameter of the wire multipole at the entrance can be at least equal to 50% of the diameter of the free jet and gas jet, and, in various aspects, larger than the diameter of the free jet. In various embodiments, the ratio of the space between the wires (X) to the wire diameter (D) wire can be >3×; in various aspects, it can be >5×; and in various aspects, it can be >10× in order to provide the least disturbance to the gas jet. It should be noted that conventional multipole ion guides can have X/D of 0.5 or less depending on the number of poles. Reducing the surface area of the electrodes by using fine wires or small diameter electrodes can also reduce the formation of shock waves that can cause disturbances to the flow. Shock waves can reduce the efficiency of ion focusing and containment within the ion guide.

As shown in FIG. 11, the angle of the gas jet relative the axis of the ion guide can be controlled by tilting the plane of the orifice aperture by angle 104 so that the plane of the aperture is at an angle relative to the perpendicular plane, where the perpendicular plane is 90 degrees relative to the axis formed by the line between the orifice and the exit aperture from the vacuum chamber, which is also the central axis of the ion guide. In various aspects, alternatively, a tubular entrance aperture can be provided that is that is tilted with respect to the central axis of the ion guide. The key parameter that can control the angle of the free jet expansion, and hence the angle of the gas jet, is the angle of the plane of the aperture that is formed by the circumference of the edge of the exit aperture, whether the aperture is located in the end of the tube or located in a plate or thin disc. The direction of the expansion and the gas jet can be controlled by the walls immediately surrounding the exit aperture. In various aspects, the direction of the expansion and the gas jet can be controlled by adjusting the shape of the exit aperture, even if the circumference of the exit aperture is not planar. By any suitable adjustment of the plane of the exit aperture, or the shape of the circumference of the exit, the expansion and gas jet can be directed so that the jet is angled with respect to the ion guide, and so that the impact of the jet on the wall at the exit from the chamber is located away from the exit aperture, in order to avoid or reduce an impact pressure. The angle can be such that the main core of the gas jet is outside the boundary of the ion guide at the exit from the ion guide. The actual angle will depend on the length of the ion guide and the diameter of the gas jet. Typically, the chamber can be about 10 to about 20 cm long, and the gas jet can be of a diameter of about 3 mm up to about 10 to 15 mm, so the angle will vary from approximately 1 degree up to at least about 8.5 degrees. Larger angles can be possible in order to steer the gas jet farther away from the ion guide.

The ions can be captured and contained inside the ion guide by the wire RF multipole. In various embodiments, the multipole can comprise of wires located around the diameter of the entrance, in a circular or non-circular shape, of a size to capture the jet of ions and gas. Adjacent wires can have alternate phases of RF voltage applied. In various aspects, the number of wires can be 2n, where n is the order of the multipole. For example, if n=2, the multipole is a quadrupole. If n=4, the multipole is an octapole.

The spacing between the wires can be large in order to let the gas jet escape almost unimpeded, but the wires can be spaced closely enough that the ion beam can be contained by the RF field between the rods. In various aspects, for typical beam diameters of about 5 mm, the wire multipole can have wire diameters of about 0.1 mm and wire spacings of about 0.5 mm, and the diameter of the inscribed circle at the entrance of the multipole can be about 10 mm. In various aspects, the number wires at the entrance can then be 52. In various aspects, the wire multipole can taper toward the exit by converging a smaller number of wires toward the exit. For example, 8 of the 52 equally spaced wires around the entrance can converge to a smaller diameter of about 4 mm at the exit from the multipole to form an octapole with opposite RF phases on adjacent wires, with the other wires continuing parallel to the axis of the multipole or terminating before the end of the ion guide. In various embodiments, 8 wires can converge to a diameter of about 6 mm at the exit and 4 wires can converge to a diameter of about 4 mm at the exit, providing a transition from a higher order multipole field at the entrance to an octapolar field and then to a quadrupolar field dominated by the 4 wires with opposite phases on adjacent wires at the exit. A quadrupole field can provide a stronger focusing field to squeeze the ion beam to a smaller diameter. In various aspects, all of the wires can converge smoothly from a larger diameter at the entrance to a smaller diameter at the exit. In various aspects, when the exit aperture is relatively large, so that the ions need to be contained but not focused to a small diameter, the wires or electrodes can be parallel so that the ion guide does not converge toward the exit.

The radial velocity of the ions that tends to cause them to escape can be due to the gas jet. Typically, the axial velocity of the jet can be 200 to 400 m/s, so if the multipole is at an angle of 10 degrees, then the radial velocity component can be approximately 5 to 10 m/s. The ion guide is configured to contain the ions within the ion guide while the angled gas jet directs the majority of the gas flow to the region outside the ion guide, or at least to an area that does not intersect the area of the exit aperture, where the gas can be pumped away. The RF voltage and spacing between the wires is configured to contain the ions within the ion guide against the outflow of the gas. The requirements for the strength of containment field are known in the art. The required RF voltage can depend on the m/z value of the ion as is known in the art, and can be determined experimentally. The RF voltage is typically a user-adjustable parameter that can be tuned or scanned or ramped with m/z as the mass spectrometer is scanned over a mass range.

The voltage applied to the wire elements can be of the order of from about 50 V peak-to-peak up to at least about 500 V peak-to-peak, depending on the mass to be transmitted.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

While the applicants' teachings have been particularly shown and described with reference to specific illustrative embodiments, it should be understood that various changes in form and detail may be made without departing from the spirit and scope of the teachings. Therefore, all embodiments that come within the scope and spirit of the teachings, and equivalents thereto, are claimed. The descriptions and diagrams of the methods of the applicants' teachings should not be read as limited to the described order of elements unless stated to that effect.

While the applicants' teachings have been described in conjunction with various embodiments and examples, it is not intended that the applicants' teachings be limited to such embodiments or examples. On the contrary, the applicants' teachings encompass various alternatives, modifications, and equivalents, as will be appreciated by those of skill in the art, and all such modifications or variations are believed to be within the sphere and scope of the invention.

1. A method for performing mass analysis comprising:
generating ions from a sample in a high pressure region;
passing the ions into a vacuum chamber comprising an inlet aperture for passing the ions from the high-pressure region into the vacuum chamber, and an exit aperture for passing ions from the vacuum chamber; wherein the configuration of the inlet aperture and the pressure difference between the high pressure region and the vacuum chamber provides a supersonic free jet expansion downstream of the inlet aperture, the supersonic free jet expansion comprising a barrel shock of predetermined diameter;
providing at least one ion guide between the inlet and exit apertures, the at least one ion guide having a predetermined cross-section defining an internal volume; wherein the cross-section of the at least one ion guide is sized to be at least 50% of the predetermined diameter of the barrel shock of the supersonic free jet expansion;
applying an RF voltage to the at least one ion guide for radially confining the ions within the internal volume of the at least one ion guide; and
reducing radial gas conductance in a first section of the at least one ion guide for damping shock waves resulting from the supersonic free jet expansion.

2. The method of claim 1 wherein the step of reducing gas conductance comprises surrounding at least a first portion of the length of the at least one ion guide with an insulating sleeve.

3. The method of claim 2 wherein the sleeve comprises at least the length of the supersonic free jet expansion, optionally
wherein the length of the sleeve comprises between about 5 mm and about 30 mm, optionally
wherein the diameter of the sleeve comprises the approximate outside diameter of the at least one ion guide, and optionally
wherein the sleeve is comprised of an insulating material.

4. The method of claim 1 wherein the at least one ion guide comprises at least one multipole having a plurality of elongated electrodes, and optionally wherein the at least one multipole comprises a series of multipole ion guides.

5. The method of claim 4 wherein the at least one multipole ion guide is selected from a quadrupole ion guide having four elongated electrodes, a hexapole ion guide having six elongated electrodes, and an octapole ion guide having eight elongated electrodes, and any combination thereof, optionally
wherein the step of reducing gas conductance comprises reducing the spacing between the elongated electrodes to a distance of less than 0.2 R₀, wherein R₀ is the radius of the circle inscribed within the ion guide, optionally
wherein the rods of the at least one multipole ion guide are selected from one of oblate elongated electrodes and circular elongated electrodes, optionally
wherein the spacing between the elongated electrodes comprises between about 0.4 mm and about 1.5 mm, and optionally.

6. The method of claim 5 wherein the spacing between the elongated electrodes is maintained for a distance of at least about 5 cm along the length of the at least one ion guide.

7. The method of claim 5 wherein the elongated electrodes comprise protuberances, and optionally
wherein the protuberances comprise a width that is less than approximately half the width of the rods in the longest dimension perpendicular to the longitudinal axis, and more than about 1 mm in height.

8. The method of claim 1 wherein the inlet aperture is circular and has a diameter between about 0.1 and about 2 mm, and optionally
wherein the circular inlet aperture comprises a diameter of about 0.7 mm.

9. The method of claim 1 wherein the predetermined cross-section forms an inscribed circle and has a diameter is between about 3 and about 15 mm.

10. The method of claim 1 wherein the vacuum chamber has a pressure between about 1 and about 20 torr, and optionally
wherein the vacuum chamber has a pressure of about 3 torr.

11. The method of claim 1 wherein the at least one ion guide comprises a first ion guide followed by a second ion guide wherein the second ion guide comprises a smaller diameter than the first ion guide, optionally
wherein the second ion guide comprises electrodes with inner surfaces that tilt toward the axis in the direction of ion flow, and optionally
wherein the diameter of the inscribed circle within the second ion guide is about 4 mm at an entrance end and about 2 mm at an exit end.

12. A mass spectrometer comprising:
an ion source for generating ions from a sample in a high pressure region;
a vacuum chamber comprising an inlet aperture for passing the ions from the high-pressure region into the vacuum chamber, and an exit aperture for passing ions from the vacuum chamber; wherein the configuration of the inlet aperture and the pressure difference between the high pressure region and the vacuum chamber provides a supersonic free jet expansion downstream of the inlet aperture, the supersonic free jet expansion comprising a barrel shock of predetermined diameter;
at least one ion guide between the inlet and exit apertures, the at least one ion guide having a predetermined cross-section defining an internal volume; wherein the cross-section of the ion guide is sized to be at least 50% of the predetermined diameter of the barrel shock of the supersonic free jet expansion;
a power supply for providing an RF voltage to the at least one ion guide for radially confining the ions within the internal volume of the at least one ion guide; and
an insulating sleeve for reducing radial gas conductance, the sleeve surrounding at least a first portion of the at least one ion guide for damping shock waves resulting from the supersonic free jet expansion.

13. The mass spectrometer of claim 12 wherein the sleeve comprises at least the length of the supersonic free jet expansion, optionally
wherein the length of the sleeve comprises between about 5 mm and about 30 mm, optionally
wherein the diameter of the sleeve comprises the approximate outside diameter of the at least one ion guide, optionally
wherein the sleeve is comprised of an insulating material, and optionally
wherein the at least one ion guide comprises a series of multipole ion guides.

14. A mass spectrometer comprising:
an ion source for generating ions from a sample in a high pressure region;
a vacuum chamber for comprising an inlet aperture for passing the ions from the high-pressure region into the vacuum chamber, and an exit aperture for passing ions from the vacuum chamber; wherein the configuration of the inlet aperture and the pressure difference between the high pressure region and the vacuum chamber provides a supersonic free jet expansion downstream of the inlet aperture, the supersonic free jet expansion comprising a barrel shock of predetermined diameter;
at least one ion guide between the inlet and exit apertures, the at least one ion guide having a predetermined cross-section defining an internal volume; wherein the cross-section of the at least one ion guide is sized to be at least 50% of the predetermined diameter of the barrel shock of the supersonic free jet expansion; the at least one ion guide comprising at least one multipole ion guide having a plurality of elongated electrodes wherein the spacing between the elongated electrodes is reduced to a distance of less than 0.2R₀, and wherein R₀ is the radius of the inscribed circle between the electrodes; and
a power supply for providing an RF voltage to the at least one ion guide for radially confining the ions within the internal volume of the at least one ion guide.

15. The mass spectrometer of claim 14 wherein the at least one multipole ion guide is selected from a quadrupole ion guide having four elongated electrodes, a hexapole ion guide having six elongated electrodes, and an octapole ion guide having eight elongated electrodes, and any combination thereof, optionally
wherein the rods of the at least one multipole ion guide are selected from one of oblate elongated electrodes and circular elongated electrodes, optionally
wherein the predetermined cross-section forms an inscribed circle and has a diameter is between about 3 and about 15 mm, and optionally
wherein the at least one multipole ion guide comprises a series of multipole ion guides.

16. The method of claim 14 wherein the spacing between the elongated electrodes comprises between about 0.4 mm and about 1.5 mm, and optionally
wherein the spacing between the elongated electrodes is maintained for a distance of at least about 5 cm along the length of the at least one ion guide.

17. The mass spectrometer of claim 14 wherein the elongated electrodes comprise protuberances, and optionally
wherein the protuberances comprise a width that is less than approximately half the width of the rods in the longest dimension perpendicular to the longitudinal axis, and more than about 1 mm in height.

18. The mass spectrometer of claim 14 wherein the inlet aperture is circular and has a diameter between about 0.1 and about 2 mm, and optionally
wherein the circular inlet aperture comprises a diameter of about 0.7 mm.

19. The mass spectrometer of claim 14 wherein the vacuum chamber has a pressure between about 1 and about 20 torr, and optionally
wherein the vacuum chamber has a pressure of about 3 torr.

20. The mass spectrometer of claim 14 wherein the at least one ion guide comprises a first ion guide followed by a second ion guide wherein the second ion guide comprises a smaller diameter than the first ion guide, optionally
wherein the second ion guide comprises electrodes with inner surfaces that tilt toward the axis in the direction of ion flow, and optionally
wherein the diameter of the inscribed circle within the second ion guide is about 4 mm at the entrance and about 2 mm at the exit.
